(19) United States
(12) Patent Application Publication
(10) Pub. No.: US 2026/0205476 A1
(43) Pub. Date: Jul. 16, 2026

(54) Asset Inventory Discovery Graph

(71) Applicant: CrowdStrike, Inc., Sunnyvale, CA (US)

(72) Inventors: Michael Brian Goldgeier, Ellicott City, MD (US); Yaron Tal, Ness Ziona (IL); Moshe Shimon Perez, Netanya (IL); Michael Glyer, Arlington, VA (US); Yotam Lichter, Eftat (IL)

(73) Assignee: CrowdStrike, Inc., Sunnyvale, CA (US)

(21) Appl. No.: 19/018,483

(22) Filed: Jan. 13, 2025

(51) Int. Cl. H04L 9/40

(52) U.S. Cl. CPC H04L 63/1425

(57) ABSTRACT

IT asset discovery services and external attack surface management (or EASM) services identify computers, servers, smartphones, and other devices that are exposed to the public Internet. Any device that can connect to the public Internet may be vulnerable to cybersecurity attacks. The services identify a device exposed to the public Internet by generating an asset inventory discovery graph. Graphical nodes describe asset inventory investigative records, and edges between the graphical nodes describe asset inventory investigative methods. The nodes thus capture asset investigatory details (such as website URL, IP addresses, and HTML content), and the edges capture how the asset investigatory details were discovered (such as Internet searches, DNS records, and WHOIS records). The services use the asset inventory discovery graph to identify an entity's Internet-facing assets.

### BACKGROUND

The subject matter described herein generally relates to computers and to networks and, more particularly, the subject matter relates to networked communications, to network security, and to computer security.

Cybersecurity threats are always increasing. Many cybersecurity attacks, for example, are delivered from the public Internet. If a computer, smartphone, or other device connects to the public Internet, then the device is vulnerable to cybersecurity attacks.

### SUMMARY

IT asset discovery services and external attack surface management (or EASM) services identify computers, servers, smartphones, and other devices that are exposed to the public Internet. Any device that can connect to the public Internet may be vulnerable to cybersecurity attacks. The services identify a device exposed to the public Internet by generating an asset inventory discovery graph. Graphical nodes describe asset inventory investigative records, and edges between the graphical nodes describe asset inventory investigative methods. The nodes thus capture asset investigatory details (such as website URL, IP addresses, and HTML content), and the edges capture how the asset investigatory details were discovered (such as Internet searches, DNS records, and WHOIS records). The services use the asset inventory discovery graph to identify an entity's Internet-facing assets.

### BRIEF DESCRIPTION OF THE SEVERAL VIEWS OF THE DRAWINGS

The features, aspects, and advantages of the asset inventory discovery graph are understood when the following Detailed Description is read with reference to the accompanying drawings, wherein:

FIGS. 1-2 illustrate some examples of Internet-exposed asset discovery;

FIGS. 3-5 illustrate examples of graphical data representing the asset inventory discovery graph;

FIG. 6 illustrates examples of identifier types of graphical nodes;

FIG. 7 illustrates examples of graphical edges;

FIG. 8 illustrates more examples of asset inventory investigative methods;

FIG. 9 illustrates examples of investigative identifiers;

FIG. 10 illustrate more examples of the asset inventory discovery graph;

FIG. 11 illustrates scanning examples of the public Internet;

FIG. 12 illustrates examples of discovered, Internet-exposed IT devices and other assets;

FIGS. 13-14 illustrate examples of staged assessment;

FIG. 15 illustrates examples of web interfacing;

FIG. 16 illustrates examples of nodal removal;

FIG. 17 illustrates some examples of local assessment;

FIGS. 18-20 illustrate examples of methods or operations that identify the Internet-facing IT asset exposed to the public Internet; and

FIG. 21 illustrates a more detailed example of an operating environment.

### DETAILED DESCRIPTION

Some examples relate to discovering devices connected to the Internet. As we know, nearly every day we read of another network hack, computer virus, or other cybersecurity attack. Many of these cybersecurity attacks occur because our computers, smartphones, and other devices connect to the Internet. If we click on suspicious email link, for example, or open a suspicious attachment, or download a suspicious website, then our devices connect to the Internet and are vulnerable to cybersecurity attacks. Indeed, the risk of Internet exposure is greatly magnified when large computer networks (such as NETFLIX®, GOOGLE®, APPLE®, and AMAZON®) have hundreds or even thousands of servers. If just a single server were to unexpectedly connect to the Internet, then important cloud services may be taken down by bad actors and cybersecurity attacks.

An external surface attack management service, though, quickly and elegantly documents Internet exposure. The external surface attack management (or EASM) service determines which devices are exposed to the Internet and, thus, which devices are vulnerable to cybersecurity attacks. The EASM service, for example, generates an asset inventory discovery graph. The asset inventory discovery graph describes how devices exposed to the Internet are found. The asset inventory discovery graph has nodes and edges. Each node describes an investigative record (such as a website URL, IP address, or HTML content) that is related to a user, group, company, or other entity. An edge connects two nodes, and the edge describes an investigative method that was used to link or connect the two nodes (such as an Internet search, a DNS record, or WHOIS records). The asset inventory discovery graph thus documents how a device exposed to the Internet is found. The device, in other words, can receive network or packet traffic from the public Internet, so the device is therefore vulnerable to cybersecurity attacks.

The asset inventory discovery graph and Internet-exposed device discovery will now be described more fully hereinafter with reference to the accompanying drawings. The asset inventory discovery graph, however, may be embodied in many different forms and should not be construed as limited to the examples set forth herein. These examples are provided so that this disclosure will be thorough and complete and fully convey the asset inventory discovery graph and Internet-exposed device discovery to those of ordinary skill in the art. Moreover, all the examples of the asset inventory discovery graph and Internet-exposed device discovery are intended to encompass both structural and functional equivalents thereof. Additionally, it is intended that such equivalents include both currently known equivalents as well as equivalents developed in the future (i.e., any elements developed that perform the same function, regardless of structure).

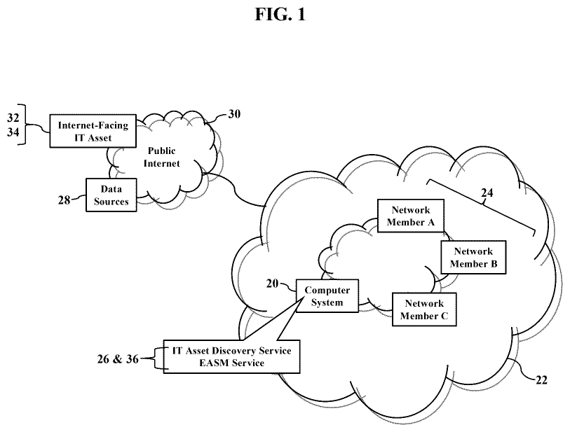

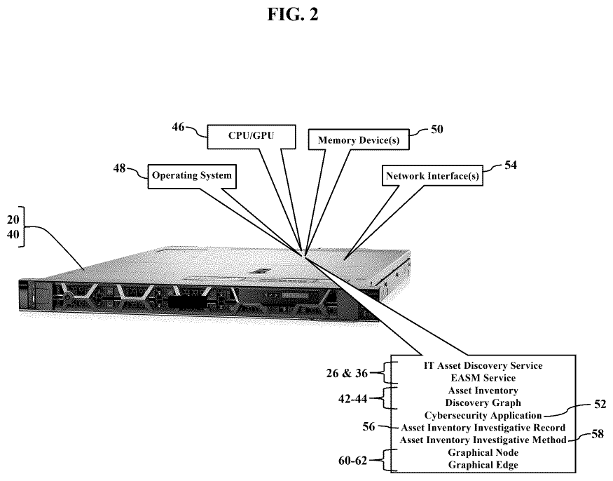

FIGS. 1-2 illustrate some examples of Internet-exposed asset discovery. A computer system 20 operates in a cloud computing environment 22. The cloud computing environment 22 (e.g., private network and/or hybrid network) has servers, devices, computers, or other networked members 24 that provide an Information Technology (or IT) asset discovery service 26 on behalf of a service provider. The IT asset discovery service 26 queries many different data sources 28 via the public Internet 30 to discover one or more Internet-facing IT assets 32 associated with a user/customer/company/entity 34. The cloud computing environment 22 may then use or incorporate the results of the IT asset discovery service 26 into an external attack surface management (or EASM) service 36. The EASM service 36, for example, identifies unknown Internet-facing IT assets 32 and recommends remediation to prevent cyberattacks.

The Information Technology (or IT) asset discovery service 26 identifies, catalogs, and documents all of the entity's Internet-facing IT assets 32. The Internet-facing IT assets 32 may include software applications, virtual machines, databases, IP addresses, and cloud services, whether they are on-premises, in the cloud, or in hybrid environments. The IT asset discovery service 26 tracks of all the components that make up the entity's IT environment. The IT asset discovery service 26, in other words, generates an inventory of the entity's Internet-facing IT assets 32. The entity's Internet-facing IT assets 32 may be hardware assets (such as servers, laptops, smartphones, printers, virtual machines (VMs), cloud instances, routers, switches, and other networking equipment). The entity's Internet-facing IT assets 32, however, may also be software assets (such as software applications, browser extensions, digital certificates, licenses, and software as a service (or SaaS)). The IT asset discovery service 26 integrates with many different data sources 28 (such as endpoint management systems, identity and access management services, cloud service providers, devices, websites, databases, and services) to capture IT asset information. The IT asset discovery service 26 aggregates the data from all these various data sources 28 to compile a comprehensive picture of the entity's IT inventory. The IT asset discovery service 26, in particular, identifies both known and unknown IT assets, the asset's operating system and configurations, the asset's software versions and needed updates, and many other details.

The external attack surface management (or EASM) service 36, in particular, pinpoints the entity's unknown Internet-facing IT assets 32. As more and more devices and services utilize the public Internet 30, the entity's digital footprint is expanding. Many organizations, corporations, and other entities 34 have seen great growth in their entitative devices that are exposed to the public Internet 30 (i.e., the Internet-facing IT assets 32). Some of the Internet-facing IT assets 32 include hardware, software, cloud workloads, IoT devices, websites, user credentials, S3 buckets, SSL certificates, operational technology (OT), rogue IT devices and more. Whatever the Internet-facing IT asset 32, each Internet-facing IT asset 32 that connects to the public Internet 30 represents a potential cybersecurity risk and a possible data breach. Indeed, cyber adversaries often exploit unknown Internet-facing IT assets 32 and their vulnerabilities. The EASM service 36, however, uses the results of the IT asset discovery service 26 to identify the entity's known, and unknown, Internet-facing IT assets 32. Once the Internet-facing IT assets 32 are determined, the EASM service 36 discovers exposures, risks, and misconfigurations generates actionable remediation steps.

FIG. 2 illustrates more examples of the IT asset discovery service 26 and the external attack surface management (or EASM) service 36. The computer system 20 is affiliated with the cloud computing environment 22 and participates in the IT asset discovery service 26 and/or the EASM service 36. FIG. 2 illustrates the computer system 20 as a rack server 40, which is commonly installed in many server rooms and server farms. The rack server 40 is programmed to provide at least a portion of the services 26 and 36 by generating graphical data 42 representing an asset inventory discovery graph 44. The rack server 40, for example, has at least one hardware processor 46 (illustrated as “CPU/GPU”) that executes an operating system 48 stored in a memory device 50. The hardware processor 46 also executes a cybersecurity application 52 stored in the memory device 50. The rack server 40 also has network interfaces 54 to multiple communications networks (such as the cloud computing environment 22 and/or the public Internet 30 illustrated in FIG. 1), thus allowing bi-directional communications with networked devices. When the rack server 40 is requested or instructed to generate the graphical data 42 representing the asset inventory discovery graph 44, the cybersecurity application 52 may be a computer program, instruction(s), or code that instructs or causes the rack server 40 to retrieve electronic data representing asset inventory investigative records 56. The cybersecurity application 52 also instructs or causes the rack server 40 to retrieve electronic data representing asset inventory investigative methods 58. The cybersecurity application 52 then instructs or causes the rack server 40 to generate the graphical data 42 representing the asset inventory discovery graph 44 using the asset inventory investigative records 56 and the asset inventory investigative methods 58. The cybersecurity application 52, for example, causes the rack server 40 to represent each asset inventory investigative record 56 as a graphical node 60 associated with the asset inventory discovery graph 44. When two (2) or more asset inventory investigative records/nodes 56/60 are related (as later paragraphs will explain), the cybersecurity application 52 causes the rack server 40 to represent the corresponding asset inventory investigative method 58 as a graphical edge 62 connecting or linking the records/nodes 56/60. Once the rack server 40 generates the graphical data 42 representing the asset inventory discovery graph 44, the graphical data 42 representing the asset inventory discovery graph 44 may be used to provide the IT asset discovery service 26 and/or the EASM service 36.

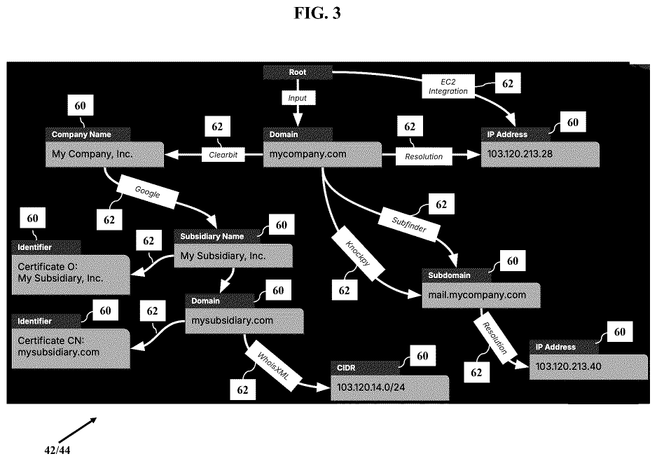

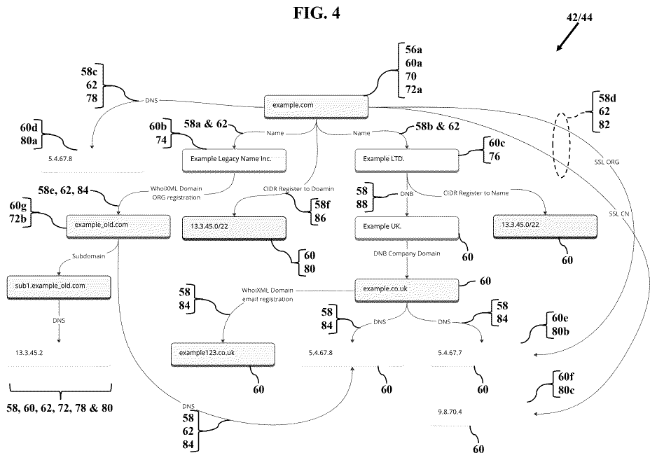

FIGS. 3-5 illustrate examples of the graphical data 42 representing the asset inventory discovery graph 44. The asset inventory discovery graph 44 captures an output of the IT asset discovery service 26 (illustrated in FIGS. 1-2). The graphical data 42 representing the asset inventory discovery graph 44 holds a complete data representation (e.g., a graphical picture) of all knowledge identified about the entity's digital footprint and how that information was discovered. The graphical data 42 (representing the asset inventory discovery graph 44) has the edges 62 that connect investigatively-related nodes 60. Each graphical node 60, for example, may be a single fact that has been identified about the user/group/company/organization/entity 34 (illustrated in FIG. 1). In FIG. 4, for example, node 60a identifies a known company domain name 70 as a starting/root asset inventory investigative record 56a. Once the domain name 70 is determined, a download and read/scan of the corresponding website 72a (i.e., the asset inventory investigative methods 58a-b) reveals graphical edges 62 connecting to a company name 74 (node 60b) and a subsidiary name 76 (node 60c). A query of domain name service (or DNS) records 78 (i.e., the asset inventory investigative method 58c) reveals graphical edges 62 connecting to a network/IP address or subnet 80a (node 60d). Moreover, a query of secure socket layer (or SSL) certificate data 82 (i.e., the asset inventory investigative method 58d) may identify more graphical edges 62 connecting to additional entitative network/IP addresses or subnets 80b-c (nodes 60e-f).

Further asset inventory investigative methods 58 may be implemented. For example, once the company name 74 (node 60b) is identified, WHOIS databases 84 may be queried (i.e., the asset inventory investigative methods 58e-f) identifying registration records and more entitative websites 72b (node 60g). Once more websites 72 are identified, repeated asset inventory investigative methods 58 (such as the DNS records 78) may identify even more network/IP address or subnets 80. Moreover, once the domain name 70 and/or the website 72 is determined, more asset inventory investigative methods (such as 58f) may query and/or inspect Classless Inter-Domain Routing (or CIDR) data records 86 to identify still more entitative network/IP address or subnets 80. Indeed, the asset inventory investigative methods 58 may include querying commercial/business databases 88 (such as DUN & BRADSTREET®) to identify additional, entitative company names 74 and/or domain names 70 as more nodes 60. Each edge 62 (that corresponds to the particular the asset inventory investigative method 58) may capture the software/hardware/service tool or method used to identify the related node 60.

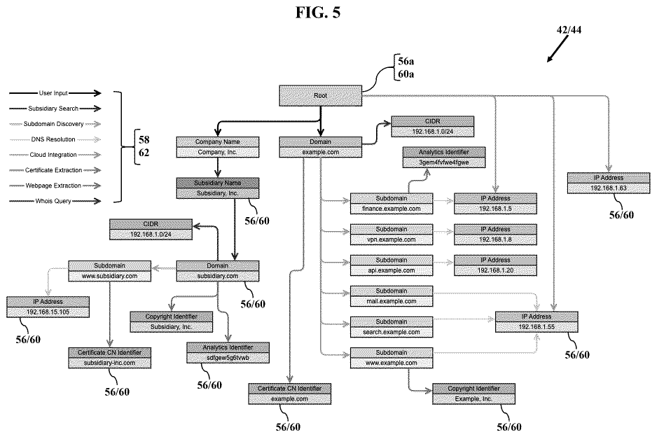

As FIG. 5 best illustrates, the asset inventory discovery graph 44 is an elegant solution. The asset inventory discovery graph 44 provides a factual representation of the entity's digital footprint. Each asset inventory investigative record 56 is plotted as one of the graphical nodes 60, and the corresponding asset inventory investigative method 58 represents the graphical edge 62 connecting or linking related asset inventory investigative records 56. FIG. 5, in particular, illustrates many different asset inventory investigative methods 58 representing many different graphical edges 62. The asset inventory discovery graph 44 thus illustrates how the entity's Internet-facing IT assets 32 are factually discovered. The asset inventory discovery graph 44 provides a complete picture for how every Internet-facing IT asset 32 in an organization's inventory was discovered, including multiple discovery paths when applicable. With this information, the clearest discovery path can be presented to an end user, or all other paths can be presented as well. If an Internet-facing IT asset 32 is deleted from the inventory, any relevant graph nodes 60 may also be removed. Disconnected subgraphs under that node 60 may be nearly instantly removed, along with all associated Internet-facing IT assets 32 that no longer attach to a modified asset inventory discovery graph 44. This ability allows the IT asset discovery service 26 and/or the EASM service 36 to perform nearly instantaneous removals without needing to rerun a full scan, but still allow the IT asset discovery service 26 and/or the EASM service 36 to correctly remove all assets affected by the change. The graphical data 42 (representing the asset inventory discovery graph 44) may also provide a mechanism for running partial scans on only select factual nodal items. For example, using the graph structure representing the asset inventory discovery graph 44, the IT asset discovery service 26 and/or the EASM service 36 may rescan Internet-facing IT assets 32 discovered through a particular identifier and avoid the rest of the assets. Generalizing, the asset inventory discovery graph 44 allows the IT asset discovery service 26 and/or the EASM service 36 to act in a more efficient manner and capture a better understanding of the entity's digital footprint. The asset inventory discovery graph 44 uniquely captures the asset discovery process of information about the entity 34. The asset inventory discovery graph 44 presents the investigative data/methods into a useful, visual format.

The asset inventory discovery graph 44 is a new data structure and a new analysis tool for understanding the entity's digital footprint. The asset inventory discovery graph 44 presents the graphical nodes 60 of significant values and the graphical edges 62 representing asset inventory investigative methods 58. The graphical edges 62, in other words, link related graphical nodes 60 by how they were identified. The asset inventory discovery graph 44 may further utilize unique nodal keys that may be correlated between different digital footprint generations. The asset inventory discovery graph 44 may even represent different confidences, sources, and weighting factors.

The asset inventory discovery graph 44 may have many characteristics. The asset inventory discovery graph 44, for example, may be directed in that an edge 62 has a single (1) source and single (1) target. The asset inventory discovery graph 44 may potentially be cyclic, so an edge 62 may point to a node 60 that would create a loop. The asset inventory discovery graph 44 may be weighted, thus allowing one or more edge weight values to be assigned to an edge 62 (perhaps based on an investigatory methodical confidence and/or other weighting factors). The edge weight values, as more examples, may be used for discovery path identification (among other uses). The asset inventory discovery graph 44 may have a single root, such as a single special node 60 is at the root of the asset inventory discovery graph 44.

As FIGS. 3-5 further illustrate, the asset inventory discovery graph 44 may have many different graphical nodes 60. The asset inventory discovery graph 44, for example, may have a root node 60 as a singleton, root of the graph 44 with no value. The asset inventory discovery graph 44 may have a URL, website, IP address, or other domain as a node 60, and the domain may represent a root domain. The asset inventory discovery graph 44 may have other URL, website, IP address, or other subdomain as another node 60 that represents a subdomain. The asset inventory discovery graph 44 may have a company name as a node 60, and the company name may represent a name of the user/group/company/organization/entity 34. The asset inventory discovery graph 44 may have subsidiary names as other nodes 60 that represent names of subsidiary users/groups/companies/organizations/entities 34. The asset inventory discovery graph 44 may have still more types of graphical nodes 60, such as an IP address that represents an individual IP address. The asset inventory discovery graph 44 may have still more types of graphical nodes 60, such as the Classless Inter-Domain Routing (or CIDR) that represents a CIDR block of addresses/subnets.

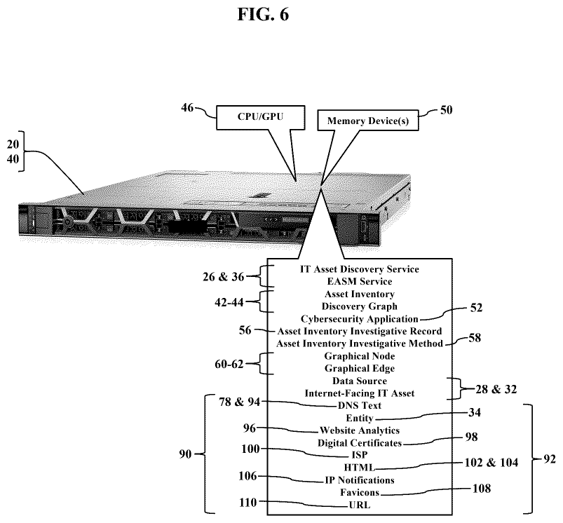

FIG. 6 illustrates examples of identifier types of graphical nodes 60. The cybersecurity application 52 programs the computer system 20 (again illustrated as the rack server 40) to generate the graphical data 42 representing the asset inventory discovery graph 44. The graphical data 42 relates, maps, or associates the graphical nodes 60 (representing the asset inventory investigative records 56) and the graphical edges 62 (representing the asset inventory investigative methods 58). The graphical nodes 60 representing the asset inventory investigative records 56, for example, may be asset inventory investigative identifiers 90. Each graphical node 60, in other words, may represent a piece of electronic data extracted from the data source 28 and used to identify connected Internet-facing IT assets 32. The asset inventory investigative identifiers 90 may also be associated with one or more subtypes 92. For example, the subtype 92 may be DNS TXT 94 extracted from the domain name service (or DNS) records 78. As the IT asset discovery service 26 and/or the EASM service 36 scrapes/scours/queries the data sources 28 to harvest/retrieve IT facts (e.g., the asset inventory investigative records 56), the cybersecurity application 52 may receive or retrieve the DNS textual data 94 that is associated with the entity 34. Data collection may further reveal more asset inventory investigative identifiers 90, such as website analytics 96. Many services, applications, and/or websites add measurement code (such as GOOGLE ANALYTICS®) to track performance, usage, and other insights. As the services, applications, and/or websites are read, the IT asset discovery service 26 and/or the EASM service 36 may collect the website analytics 96 associated with the entity 34.

Digital certificates 98 may also be collected. As the services, applications, and/or websites are read, the IT asset discovery service 26 and/or the EASM service 36 may read and identify the digital certificates 98 associated with the entity 34. The Common Name (or CN) certificate, for example, represents the server name protected by a Secure Sockets Layer (or SSL) certificate. The public key certificate includes a public key information, owner/subject information (such as the entity 34), and a digital signature associated with the entity 34. Other digital certificates 98, for example, may identify an organization (such as a top level company name). Still other digital certificates 98 may identify an organizational unit (such as a sub-unit of the top level organization, a department, a group, and/or a team).

Still more asset inventory investigative identifiers 90 may be collected. As the services, applications, and/or websites are read, the IT asset discovery service 26 and/or the EASM service 36 may read data identifying an Internet Service provider (or ISP) 100 associated with the entity 34. Indeed, the IT asset discovery service 26 and/or the EASM service 36 may read and store any programming code or statements 102 (such as Hyper-Text Markup Language 104) associated with the entity 34. As the IT asset discovery service 26 and/or the EASM service 36 queries the data sources 28, all data attributed to, and/or associated with, the entity 34 may be read and logged for analysis. Copyright, trademark, patent, and trade secret (e.g., intellectual property or IP) notifications 106, for example, may be graphed and related to other nodes 60 and edges 62. Iconic favicons 108, as more examples, may be read from websites/webpages associated with the entity 34. The favicons 108 may be plotted as the graphical nodes 60 and linking/connecting edges 62 reference the asset inventory investigative methods 58. Uniform resource locators (or URLs) 110 may also be read and analyzed as nodal asset inventory investigative records 56.

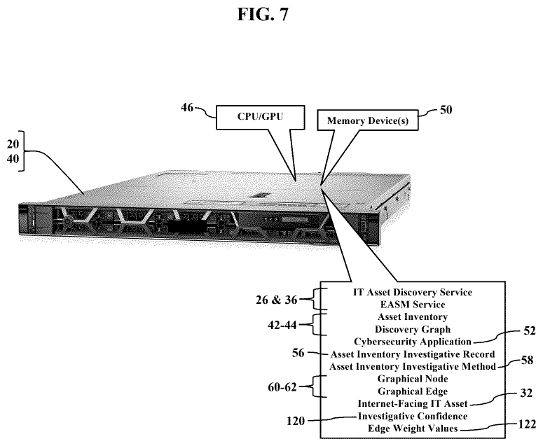

FIG. 7 illustrates examples of the graphical edges 62 (representing the asset inventory investigative methods 58). The cybersecurity application 52 programs the computer system 20 (again illustrated as the rack server 40) to generate the graphical data 42 representing the asset inventory discovery graph 44. The graphical data 42 relates, maps, or associates the graphical nodes (representing the asset inventory investigative records 56) and the graphical edges 62 (representing the asset inventory investigative methods 58). The graphical edges 62 representing the asset inventory investigative methods 58, for example, may indicate how the corresponding graphical nodes 60 were found. The graphical edge 62, for example, may indicate or explain the data source 28 interconnecting two nodes 60. The graphical edge 62, however, may indicate an investigative confidence 120. Because the graphical edge 62 represents the asset inventory investigative method 58 that links/relates two interconnecting nodes 60, the investigative confidence 120 measures or represents the confidence level in the asset inventory investigative method 58 that links/relates the two interconnecting nodes 60. The graphical edge 62, moreover, may be weighted with one or more edge weight values 122. Each edge weight value 122 may represent a strength, contribution, importance, or other influential factor. Some asset inventory investigative methods 58 may thus be more revealing, or more accurate, of the Internet-facing IT assets 32, so these asset inventory investigative methods 58 may be associated with higher/greater edge weight values 122. Other asset inventory investigative methods 58, though, may be less revealing or perhaps less accurate, so these asset inventory investigative methods 58 may be assigned low or small edge weight values 122.

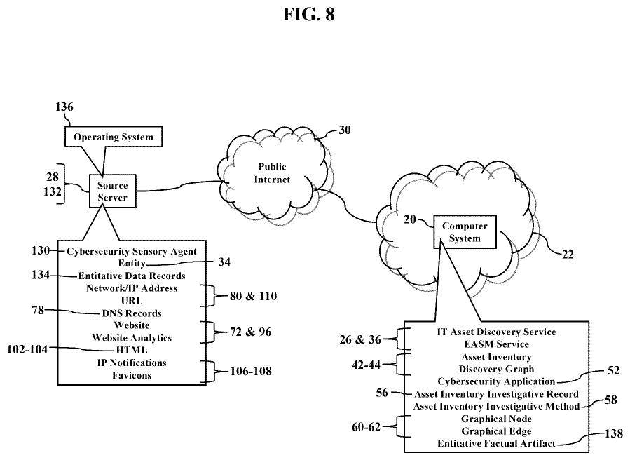

FIG. 8 illustrates more examples of the asset inventory investigative methods 58. When the IT asset discovery service 26 scours the data sources 28, some of the data sources 28 may be an endpoint cybersecurity sensory agent 130. FIG. 8, for example, illustrates a source server 132 storing and executing the endpoint cybersecurity sensory agent 130. The cybersecurity sensory agent 130 is a software product that monitors the source server 132 for entitative data records 134 associated with the entity 34. The entitative data records 134, for example, may be the network/IP address/subnet 80 and/or the uniform resource locator (or URL) 110 associated with the entity 34. The entitative data records 134, as more examples, may be the domain name service (or DNS) records 78 associated with the entity 34. The entitative data records 134, as still more examples, may be the website analytics 96 (such as GOOGLE ANALYTICS®) read from the website 72 hosted by, or stored by, the source server 132. The entitative data records 134, as yet more examples, may be the hypertext markup language (or HTML) 102 or other programming languages/statements 104 read from the website 72 hosted by, or stored by, the source server 132. Indeed, the entitative data records 134, as more examples, may be electronic content represented by the website 72, such as the copyright/trademark/patent/trade secret (e.g., intellectual property or IP) notifications 106 and/or the favicon 108. Whatever the entitative data records 134 associated with the entity 34, cybersecurity sensory agent 130 cooperates with a local operating system 136 (also executed by the source server 132) to intercept the entitative data records 134 (such as OS events associated with the entity 34). When the operating system 136 notifies the cybersecurity sensory agent 130 of the entitative data records 134, the cybersecurity sensory agent 130 may report the entitative operating system events and/or the entitative data records 134 to a network address associated with the IT asset discovery service 26 and/or the EASM service 36. When the computer system 20 receives the entitative data records 134, the cybersecurity application 52 instructs the computer system 20 to generate the graphical data 42 representing the asset inventory discovery graph 44. The graphical data 42, for example, may represent the entitative data records 134 as the graphical nodes 60, and the graphical edges 62 identify the cybersecurity sensory agent 130 (e.g., a unique agent identifier) as the asset inventory investigative method 58. Each graphical node 60, in other words, represents a different entitative factual artifact 138, and each edge 62 documents how the entitative factual artifact 138 was found (i.e., reported by the cybersecurity sensory agent 130). Simply put, the graphical data 42 describes the endpoint cybersecurity sensory agent 130 as the data source 28.

The asset inventory discovery graph 44 captures the process by which IT assets are discovered. The nodes 60 capture entitative factual artifacts, and the edges 62 capture how the entitative factual artifacts were discovered. The asset inventory discovery graph 44 starts with a root node 60 and then from there add nodes 60 that were input from a user (such as a root domain at minimum). From there, the IT asset discovery service 26 and/or the external attack surface management (or EASM) service 36 discovers other pieces of factual information and adds additional nodes 60. Indeed, the identifier node 60/90/92 represents entitative facts for discovering unknown IT assets 32. The edges 62 that connect the source/target nodes 60 capture how the target node 60 was discovered. So, for each edge 62, the asset inventory discovery graph 44 specifies the method 58 through which the discovery was made.

The edges 62 have many examples. Given a company name, for example, the services 26 and/or 36 may query Dun & Bradstreet's database and identify a subsidiary company. An edge 62 may thus connect the company name node 60 with the subsidiary name node 60, and the edge 62 would have source=DnB. The endpoint cybersecurity sensory agent 130, for example, may be installed on one of the entity's computer assets. When the endpoint cybersecurity sensory agent 130 notifies of an entitative factual artifact, that node 60 may have a high confidence 120 that the asset 32 belongs to the entity. The edge 62 may thus link or connect the Root node 60 and an IP Address node 60 of that asset with source=sensor 130. From a Domain, the WhoisXML service may be used to lookup CIDR ranges assigned to the company/entity. Another edge 62 may thus connect from the domain node 60 to one or more CIDR nodes 60. The edge 62 would capture source=WhoisXML (perhaps with the confidence level 120). From a webpage, the HTML 102/104 may be loaded and scanned/read to locate identifying text (such as IP notifications 106). The HTML 102/104 may thus link other assets that belong to the entity and stored as an Identifier node 60 in the asset inventory discovery graph 44. An edge 62 may connect from the domain of the website to the Identifier node 60 and specify source=Copyright. Similarly, a website analytics token may be extracted to produce an Identifier node 60 with an edge 62 specifying the analytics extraction.

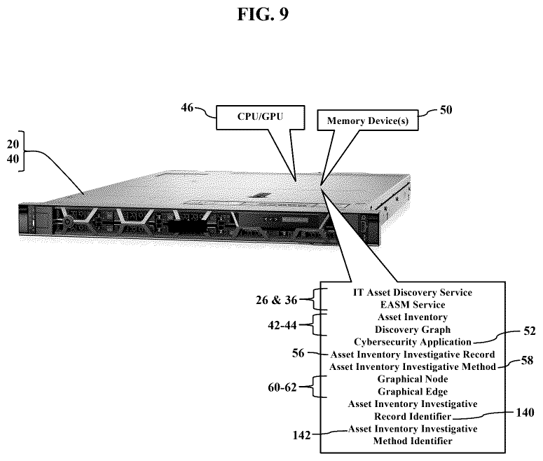

FIG. 9 illustrates examples of investigative identifiers. The graphical data 42 representing the asset inventory discovery graph 44 relates, maps, or associates the graphical nodes 60 (representing the asset inventory investigative records 56) and the graphical edges 62 (representing the asset inventory investigative methods 58). Each graphical node 60, for example, may be associated with a unique asset inventory investigative record identifier 140. Each node's asset inventory investigative record identifier 140 may be deterministic. While other identifying schemes may be used, the cybersecurity application 52 may program the computer system 20 (again illustrated as the rack server 40) to generate each node's asset inventory investigative record identifier 140 using its corresponding node type (such as the asset inventory investigative identifier 90 and/or subtype 92 illustrated in FIG. 6) and node value. The cybersecurity application 52, for example, may call or invoke a hashing algorithm to determine a hash value representing the node value. The node's asset inventory investigative record identifier 140 may thus be recorded/stored as

[type]:[value hash] (such as identifier:
407f4f522c61b813eedc7de4cc199618).

Again, though, other nodal naming/identifying schemes may be used to suit performance, cost, and other objectives.

The edges 62 may also be uniquely identified. Each graphical edge 62 may be p associated with a unique asset inventory investigative method identifier 142. Each edge's asset inventory investigative method identifier 142 may be deterministic. While other identifying schemes may be used, the cybersecurity application 52 may program the computer system 20 (again illustrated as the rack server 40) to generate each edge's asset inventory investigative method identifier 142 using the edge's linked/connected graphical nodes 60. That is, because the graphical edge 62 connects two (2) investigatively-related graphical nodes 60, the edge's asset inventory investigative method identifier 142 may be generated using the corresponding nodal asset inventory investigative record identifiers 140. The cybersecurity application 52, for example, may concatenate the source node ID 140, the target node ID 140, and the data source 28 as

knockpy:domain:xxxxxxxxx:subdomain:xxxxxxxxx.

Again, though, other nodal naming/identifying schemes may be used to suit performance, cost, and other objectives.

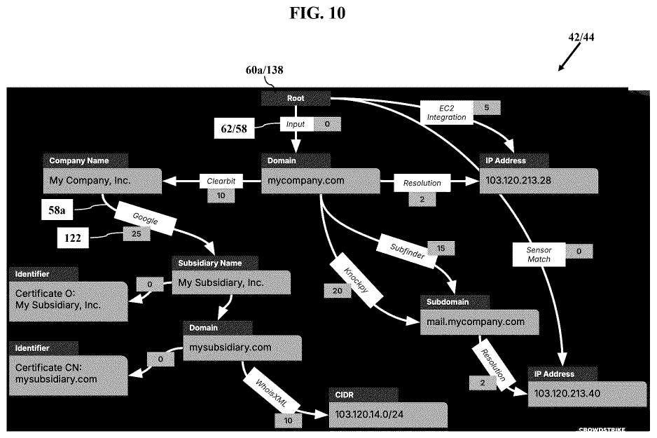

FIG. 10 illustrate more examples of the asset inventory discovery graph 44. FIG. 10 illustrates different asset inventory investigative methods 58 from the root/source node 60a. Each hierarchical or subnode (i.e., target node) 60 represents a different entitative factual artifact 138, and each edge 62 documents how the entitative factual artifact 138 was found (i.e., the asset inventory investigative method 58). FIG. 10 also illustrates the edge weight values 122 assigned or applied to the graphical edges 62. Again, some asset inventory investigative methods (such as GOOGLE® search 58a) may thus be more revealing, or more accurate, of the Internet-facing assets 32, so these asset inventory investigative methods 58 may be associated with higher/greater edge weight values 122. Other asset inventory investigative methods 58, though, may be discounted as less revealing or inaccurate.

The asset inventory discovery graph 44 greatly improves the IT asset discovery service 26 and the EASM service 36. The graphical data 42, representing the asset inventory discovery graph 44, identifies each IT entitative factual artifact 138 (i.e., the graphical node 60) and how the entitative factual artifact 138 was found (i.e., the asset inventory investigative method 58). The asset inventory discovery graph 44 thus greatly improves discovery path identification. Indeed, when the computer system 20 (such as the rack server 40) processes the graphical data 42 for output to a display device, the asset inventory discovery graph 44 visually presents a simple illustration of the entitative IT asset investigative process. The IT asset discovery service 26, the EASM service 36, and/or the cybersecurity application 52 may traverse the graphical nodes 60 (e.g., via the graphical edges 62) to find all possible paths to an Internet-facing IT asset 32. The cybersecurity application 52, as an example, may use a graph shortest-path algorithm (such as Dijkstra's algorithm) to find the best path, or N best paths, to an Internet-facing IT asset 32. The cybersecurity application 52, as another example, may use a weighting algorithm to determine the edge weight values 122. The cybersecurity application 52 may also adjust the edge weight values 122 to prefer, promote, or demote one or more graphical edges 62 between entitative factual artifacts 138 (i.e., the graphical nodes 60).

The asset inventory discovery graph 44 also greatly improves computer functioning. The graphical data 42 representing the asset inventory discovery graph 44 provides investigative breadcrumbs. The graphical data 42 log and document the exposed Internet-facing IT assets 32 that are susceptible to cyberbreaches. The computer system 20 (such as the rack server 40) providing at least portions of the IT asset discovery service 26 and/or the EASM service 36 uses the graphical data 42 to identify the Internet-facing IT assets 32 that are under-protected, misconfigured, misprovisioned, and/or susceptible to cyberattacks.

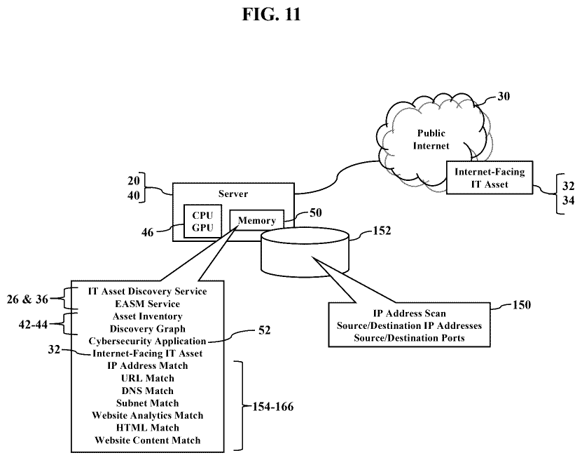

FIG. 11 illustrates scanning examples of the public Internet 30. The IT asset discovery service 26 and/or the EASM service 36 may compare the graphical data 42 (representing the asset inventory discovery graph 44) to an IP address scan 150. In FIG. 11, for example, the EASM service 36 maintains an electronic public IP address database 152 that logs open ports associated with devices connected to the public Internet 30. The IT asset discovery service 26 and/or the EASM service 36, for example, may log records describing the IP addresses, ports, and other electronic data harvested from the public Internet 30. The EASM service 36, for example, may have components or services (such as Internet surface mappers) that ping/contact/query as many public IP addresses as possible and log each response (such as source IP address, destination IP address, source port, destination port, and other data) associated with every device or host on the public Internet 30. The EASM service 36, of course, may not reach every device on the Earth or in the universe, as many devices are simply not reachable for many reasons not relevant here. The EASM service 36, then, may query or contact as many hosting devices and/or public IP addresses as reasonably/feasibly possible and log each response. While the public IP address database 152 may be maintained by a networked member 24 of the cloud computing environment 22 (illustrated in FIG. 1), FIG. 11 illustrates a simple example of local hosting. The public IP address database 152 is illustrated as being locally stored in the memory device 50 of the rack server 40. The cybersecurity application 52 reads the graphical data 42 representing the asset inventory discovery graph 44. The cybersecurity application 52 then compares the graphical data 42 to the database entries in the public IP address database 152. The public IP address database 152 includes database entries that log, map, or otherwise associate different source/destination IP addresses, different source/destination ports, and other data discovered via the IP address scan 150 associated with the public Internet 30.

Data matches may identify the Internet-facing IT asset 32. The cybersecurity application 52, for example, instructs the hardware processor 46 to compare the graphical data 42 (representing the asset inventory discovery graph 44) to the IP address scan 150 (as reflected by the entries of the public IP address database 152). The services 26 and/or 36 identify matches between the graphical data 42 and the IP address scan 150. The cybersecurity application 52, for example, reads and compares the IP addresses, as specified by the graphical data 42, to the entries in the public IP address database 152 that log or record the IP addresses associated with the IP address scan 150. If the cybersecurity application 52 determines that the IP address, as specified by the graphical data 42, equals, satisfies, or matches the IP address recorded by the public IP address database 152, then the cybersecurity application 52 determines and logs an IP address match 154.

Other data matches may identify the Internet-facing IT asset 32. When services 26 and/or 36 compare the graphical data 42 (representing the asset inventory discovery graph 44) to the IP address scan 150, other data matches may identify other Internet-facing IT assets 32. The cybersecurity application 52, for example, may determine a URL match 156, a DNS match 158, and/or a subnet match 160 between the graphical data 42 and the IP address scan 150. The cybersecurity application 52, as more examples, may determine a website analytics match 162 and/or an HTML match 164 between the graphical data 42 and the IP address scan 150. The cybersecurity application 52, as more examples, may determine a website content match 166 (such as the text 78/94, copyright/IP text 106, and/or the favicon 108 illustrated in FIG. 6) between the graphical data 42 and the IP address scan 150.

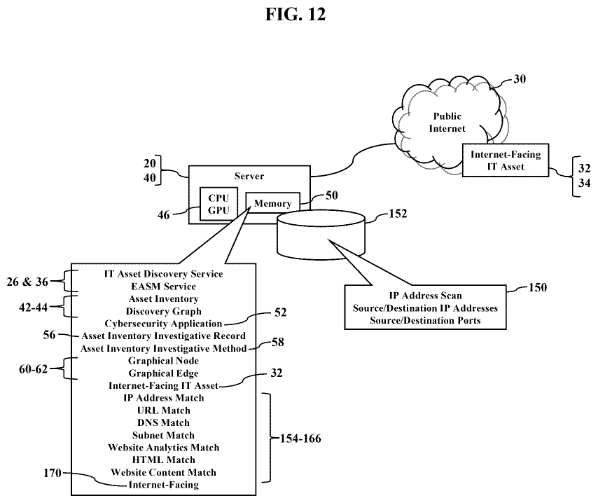

FIG. 12 illustrates examples of discovered, Internet-exposed IT devices and other assets. The IT asset discovery service 26 and/or the EASM service 36 may discover the Internet-facing IT asset(s) 32 based on the match(es) 154-166 between the graphical data 42 (representing the asset inventory discovery graph 44) and the IP address scan 150. When the cybersecurity application 52 determines the match(es) 154-166, then the cybersecurity application 52 identifies the corresponding device, application, and/or service as Internet-facing 170. The device/application/service 32/34, in other words, is exposed to the public Internet 30, so incoming Internet packet traffic is routable to the device/application/service. The corresponding device/application/service 32/34 is therefore vulnerable to a cybersecurity attack delivered via the public Internet 30.

The services 26 and/or 36 thus identify devices/applications/services that are exposed to the public Internet 30. The services 26 and/or 36 maintain a periodic partial, reasonable, and/or feasible scan of Internet Protocol (or IP) addresses associated with the public Internet 30 (e.g., the IP address scan 150). The services 26 and/or 36 thus maintain a complete database of addresses, ports, and additional data retrieved from every IPv4/6 host on the public Internet 30. Each database record thus documents the addresses, ports, additional data, and timestamp(s). The cybersecurity application 52 correlates the matches 154-166 to identify and classify the corresponding device/application/service 32/34 as the Internet-facing 170. The cybersecurity application 52 thus identifies the Internet-facing IT asset(s) 32 that are directly exposed to the public Internet 30.

The services 26 and/or 36 may merge different datasets. The external attack surface management service 36, for example, may employ computer systems (or scanners) that perform the IP address scan 150 and that log the results in the public IP address database 152. The EASM service 36, however, may also employ the cybersecurity sensory agent 130 that monitors client devices operating in the field (such as the source server 132 explained with reference to FIG. 8). When, for example, the cybersecurity sensory agent 130 detects a TCP, UDP, or other communications request, the cybersecurity sensory agent 130 may cause its host device to report the communications request to the EASM service 36. The EASM service 36 may thus merge and compare data representing the communications request to the IP address scan(s) 150 logged by the public IP address database 152. The communications request then identifies actual attributions (e.g., the data matches 154-166) that occur between the datasets.

The services 26 and/or 36 thus implement an elegant solution. The services 26 and/or 36 may periodically and automatically scan every single IP address allocated to the public Internet 30 (24 hours a day, 7 days a week) where a network connection might be made. The results of the IP address scan 150 are collected by the cloud computing environment 22 and recorded to the public IP address database 152. Moreover, every host device running the cybersecurity sensory agent 130 (as illustrated by FIG. 8) may also listen/monitor for inbound/outbound connections (such as from the public Internet 30 and/or from inside a private intranet). So, when any device on the public Internet 30 “knocks on the door” of the host device (such as a connection request), the cybersecurity sensory agent 130 reports a record of the requested or established connection to the cloud computing environment 22. The services 26 and/or 36 compare these records and looks for the matches 154-166.

The services 26 and/or 36 further improve computer functioning. The services 26 and/or 36 correlate Internet exposure with the data matches 154-166. The services 26 and/or 36 thus use packet traffic data to discover and to identify the IT assets 32 that are exposed to the public Internet 30. Simply put, the services 26 and/or 36 reveal devices that may have their processor, memory, and software resources harmed by cybersecurity attacks.

The services 26 and/or 36 further improve computer functioning. Exposed endpoints (such as the client device 20) accessed from the Internet are low hanging fruit for threat actors. Attackers are continuously scanning the public Internet 30 to find the most vulnerable exposed devices. The services 26 and/or 36 allow users, customers, and organizations to prioritize their cybersecurity risk by exposing the Internet-facing IT assets 32 that are vulnerable to cybersecurity attacks. The Internet-facing IT assets 32 are quickly revealed for immediate cybersecurity remediation. Cybersecurity and IT teams may further quickly identify and resolve misconfigurations that reduce cybersecurity attacks. For example, when the Internet-facing IT asset 32 is discovered, the services 26 and/or 36 may perform remediation action(s) that reduce cybersecurity risks associated with the Internet-facing IT asset 32. The remediation action(s), for example, may include generating a public Internet exposure notification or warning. The public Internet exposure notification or warning may be sent to notification address and thus alert recipients to the newly-discovered Internet-facing IT asset 32. The remediation action(s), however, may additionally or alternatively restrict the hardware and/or software resources associated with the Internet-facing IT asset 32. The remediation action(s), for example, may include sending an instruction to a network/IP address assigned to or associated with the Internet-facing IT asset 32, and the instruction may cause the Internet-facing IT asset 32 to impose processor/memory/network restrictions. For example, because the cybersecurity sensory agent 130 may have kernel level permissions/privileges to its host operating system 136 (such as illustrated in FIG. 8), the services 26 and/or 36 may send remediation instructions to the cybersecurity sensory agent 130. The cybersecurity sensory agent 130 may thus instruct its host operating system 136 to implement the remediation action(s), such as ignoring or terminating processes, events, and/or operations associated with Internet communications. Indeed, the cybersecurity sensory agent 130 may instruct its host operating system 136 to disable an Ethernet/Bluetooth/WIFI or other network interface and/or to drop/disregard outgoing/incoming packets of data from the public Internet. The services 26/36 and/or the cybersecurity sensory agent 130 may implement remediation actions that restrict network/communicative access.

Computer functioning is again improved. Internet exposure makes computer operations vulnerable to the cybersecurity attacks. The services 26 and/or 36, however, quickly identify entitative devices that are the Internet-facing 170. The services 26 and/or 36 thus identify attack vulnerabilities and minimizes threat opportunities and damages to devices. Because the services 26 and/or 36 maintain complete records of the entire public Internet 30, and of the entity's digital footprint, the services 26 and/or 36 are very fast and very simple to execute. The rack server 40, for example, need merely retrieve and compare service records in perhaps seconds. The cybersecurity application 52 consumes little space (in bits/bytes) in the memory device 50. Moreover, the hardware processor 46 requires less cycles and less time to classify the Internet-facing 170 asset 32. Computer resources are reduced, and less electrical power is required to test for the Internet-facing IT assets 32. The services 26 and/or 36 are thus very fast and very simple, allowing the rack server 40 to quickly assess thousands or millions of devices in the field. The cloud-based services 26 and/or 36 thus greatly improve computer functioning of the rack server 40 for detecting vulnerable Internet-facing IT assets 32.

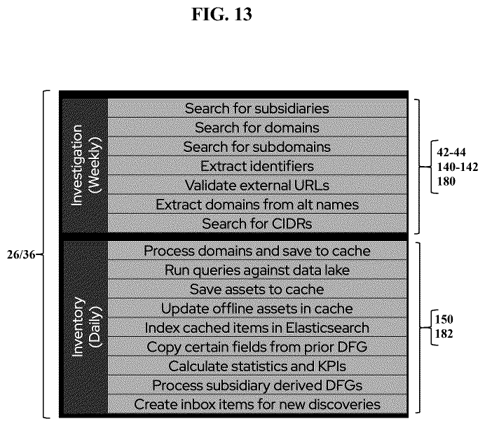

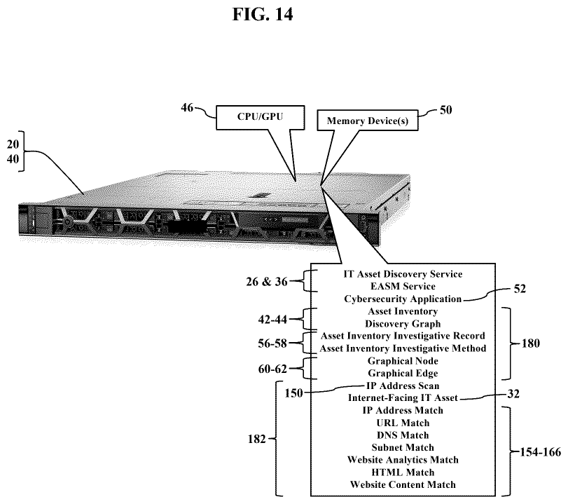

FIGS. 13-14 illustrate examples of staged assessment. The IT asset discovery service 26 and/or the EASM service 36 may be performed in stages for performance, cost, and/or other objectives. The IT asset discovery service 26 and/or the EASM service 36, for example, may have a first stage 180 and a second stage 182. The IT asset discovery service 26 and/or the EASM service 36 may generate the graphical data 42 (representing the asset inventory discovery graph 44) during the first stage 180. As FIG. 14 illustrates, for example, the cybersecurity application 52, for example, may instruct the computer system 20 (again illustrated as the rack server 40) to generate the graphical data 42 representing the entitative data records 134 as the graphical nodes 60 and the graphical edges 62 represent and identify the asset inventory investigative method 58. Each graphical node 60, in other words, represents one of the different entitative factual artifacts 138 (illustrated in FIGS. 8 & 10). Each connecting edge 62 (between two related, target/source nodes 60) documents how the entitative factual artifacts 138 were found. During the second stage 182, the IT asset discovery service 26 and/or the EASM service 36 may compare the graphical data 42 (representing the asset inventory discovery graph 44) to the results of the IP address scan 150 associated with the public Internet 30 (illustrated in FIG. 12). Perhaps also during the second stage 182, the IT asset discovery service 26 and/or the EASM service 36 may identify the Internet-facing IT asset(s) 32 exposed to the public Internet 30 based on the match(es) 154-166 between the graphical data 42 and the IP address scan 150 of the network addresses associated with the public Internet 30.

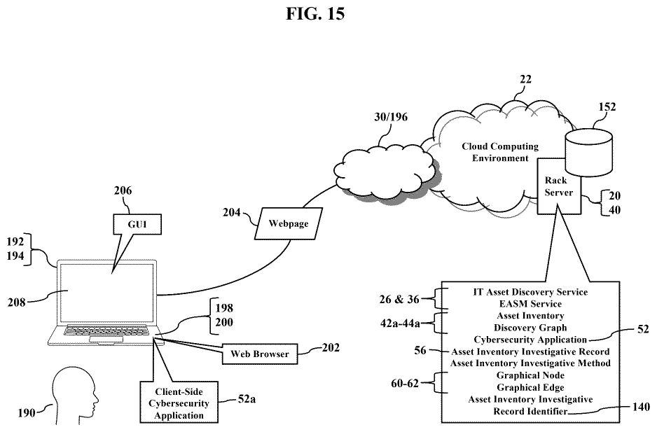

FIG. 15 illustrates examples of web interfacing. The IT asset discovery service 26 and/or the external attack surface management (or EASM) service 36 may have a user/web interface that allows user interaction and feedback. FIG. 15 thus illustrates remote access to the services 26 and/or 36. A human user 190 (such as an expert cybersecurity analyst), for example, may use an analyst's computer 192 to interface with the computer system 20 (again illustrated as the rack server 40). FIG. 15 illustrates the analyst's computer 192 as a remote laptop computer 194, but the analyst's computer 192 may be a smartphone, tablet, server, or other computer system. The analyst's computer 192 has a network interface to an access network or other communications network 196 (such as the public Internet 30), thus allowing the analyst's computer 192 to establish network communications with the cloud computing environment 22 and/or with the server 40. The analyst's computer 192 may thus have access permissions to the cloud computing environment 22 and/or to the rack server 40. The analyst's computer 192 has a hardware processor 198 that executes a client-side version 52a of the cybersecurity application stored in a memory device 200. The cybersecurity application 56 and the client-side version 52a may cooperate in a client-server relationship to facilitate a human analyst review of the graphical data 42 (representing the asset inventory discovery graph 44).

The analyst's computer 192 stores and executes a web browser 202 that interfaces with the client-side version 52a of the cybersecurity application. When the human user 190 wishes to review the graphical data 42 (representing the asset inventory discovery graph 44), the human user 190 commands the client-side version 52a of the cybersecurity application to establish communication with the rack server 40. The human user 190, in particular, may access service records associated with the IT asset discovery service 26 and/or the EASM service 36. The web browser 202 and the client-side version 52a cooperate to request and to receive a webpage 204 having content representing, for example, the asset inventory discovery graph 44. The analyst's computer 192 processes and displays the webpage 204 as a dashboard or other graphical user interface (GUI) 206 via a display device 208. The human user 190 may thus scrutinize the asset inventory discovery graph 44.

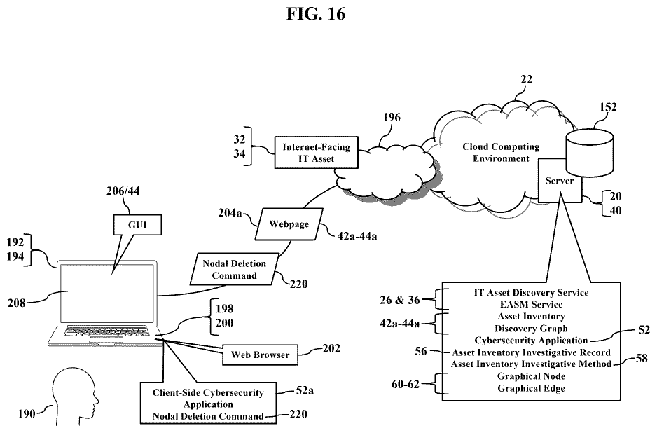

FIG. 16 illustrates examples of nodal removal. When the human user 190 scrutinizes the asset inventory discovery graph 44, the human user 190 may determine, for whatever reason(s), that one or more graphical nodes 60 should be deleted from the asset inventory discovery graph 44. The client-side version 52a of the cybersecurity application, as a simple example, may accept audible/tactile/capacitive inputs. The human user 190, for example, may select a graphical node 60 visually illustrated by the asset inventory discovery graph 44 and enter a nodal deletion command 220. The client-side version 52a of the cybersecurity application may then instruct the analyst's computer 192 to send or convey the nodal deletion command 220 to the network address associated with the IT asset discovery service 26 and/or the EASM service 36. When the IT asset discovery service 26 and/or the EASM service 36 receives the nodal deletion command 220, the networked members 24 (illustrated in FIG. 1) may forward the nodal deletion command 220 to the rack server 40 for implementation. The cybersecurity application 56, for example, reads the nodal deletion command 220 that specifies the graphical node 60 (e.g., the corresponding asset inventory investigative record identifier 140 or other nodal ID). The cybersecurity application 56 then causes the rack server 40 to delete the graphical data 42 that corresponds to graphical node 60 specified by the nodal deletion command 220. The cybersecurity application 56 instructs the rack server 40 to regenerate modified graphical data 42a representing a modified or reduced asset inventory discovery graph 44a having the selected/identified graphical node 60 deleted therefrom. The cybersecurity application 56 instructs the rack server 40 to send the modified graphical data 42a back to the network address associated with the analyst's computer 192. The rack server 40, for example, may send a modified webpage 204a having content representing, for example, the modified or reduced asset inventory discovery graph 44a. The analyst's computer 192 processes and displays the modified webpage 204a via the display device 208. The human user 190 may thus scrutinize the modified or reduced asset inventory discovery graph 44a having the graphical node 60 deleted therefrom.

Nodal removal may thus be nearly instantaneously performed. The IT asset discovery service 26 and/or the EASM service 36 may accept user inputs/commands that remove one or more selected nodes 60 from the graph structure. Whatever node 60 is deleted, the IT asset discovery service 26 and/or the EASM service 36 may nearly instantly remove all other connected nodes 60 as well, without needing to run/generate a new digital footprint. Indeed, for false nodes 60 and/or false asset inventory investigative record identifiers 140, the IT asset discovery service 26 and/or the EASM service 36 may remove the corresponding node 60. The IT asset discovery service 26 and/or the EASM service 36 may also remove the corresponding Internet-facing IT assets 32.

The graphical data 42 (representing the asset inventory discovery graph 44) may be further modified. The IT asset discovery service 26 and/or the EASM service 36 may generate partial graph updates. Individual nodes 60 or nodal subgraphs, for example, may be updated (if needed) without affecting the rest of the asset inventory discovery graph 44. Continuous nodal deletions/additions/updates, for example, may mutate the asset inventory discovery graph 44, perhaps in near real time. For example, updating entitative subsidiaries may trigger the update or removal of graphical nodes 60 and/or the Internet-facing IT assets 32.

The first stage 180 may thus be an investigation stage. The IT asset discovery service 26 and/or the EASM service 36 may accept an input by the user 190 (such as a root domain or more). The IT asset discovery service 26 and/or the EASM service 36 then uses the input to start the first state 180 dig down from there to see what else may be collected/learned (such as company subsidiaries and content from certificates). The services 26/36 may determine a CIDR and/or a specific IP address by resolution of a domain. The output of this investigation first stage 180 may be the graphical data 42 (representing the asset inventory discovery graph 44).

The second stage 182 may be the inventory generation (that is, finding entitative assets). The services 26/36 may use the graphical data 42 (representing the asset inventory discovery graph 44) find the Internet-facing IT assets 32 (such as IPs or domains) that belong to the entity by referencing the data lake associated with the IP address scan 150. In a simple case, a specific IP address specified by the asset inventory discovery graph 44 may be a direct lookup. But, it could be a search for a particular block of identifying text that indicates entitative ownership. In that case, the IP address match 154, for example, matches an IP address in IP address scan 150 that was discovered from an Identifier node 60 in the graphical data 42.

The IT asset discovery service 26 and/or the EASM service 36 thus provide improved change analysis between scans. Conventional asset discovery schemes provide unclear indications of change when comparing two digital footprint generations (or DFGs). With the deterministic node identifiers 140, though, differences between asset inventory discovery graphs 42/44 are easily illustrated to visualize the changes.

The graphical data 42 (representing the asset inventory discovery graph 44) may be a JSON graph file. The graphical data 42 defines the graphical nodes 60 and edges 62 from that run. Asset and domain records (such as APACHE PARQUET® files) are stored specifying the associated node identifiers 140. The graphical nodes 60 may be of various types (as explained with reference to FIGS. 3-5), depending on how the entitative factual artifact 138 was found (i.e., the corresponding asset inventory investigative method 58). Indeed, the entitative factual artifact 138 may reference multiple nodes 60 if discovered in multiple ways.

The IT asset discovery service 26 and/or the EASM service 36 thus provide dynamic asset discovery. The services 26 and/or 36 greatly improve IT asset discovery during digital footprint generation (or DFG). The graphical data 42 (representing the asset inventory discovery graph 44) may be exported and saved to any networked destination (such as local or cloud storage). The asset discovery path to an Internet-facing IT asset 32 is easily determined using the graphical data 42 and easily visualized using the asset inventory discovery graph 44. Moreover, the graphical data 42 may be easily mutated by calculating all the nodes 60 that are going to be removed (such as via the user's nodal deletion command 220 and/or via a false positive determination). The node 60 is deleted, perhaps along with linking/connecting/affected/associated nodes 60. Indeed, graph/tree/hierarchical differences may be determined between versions.

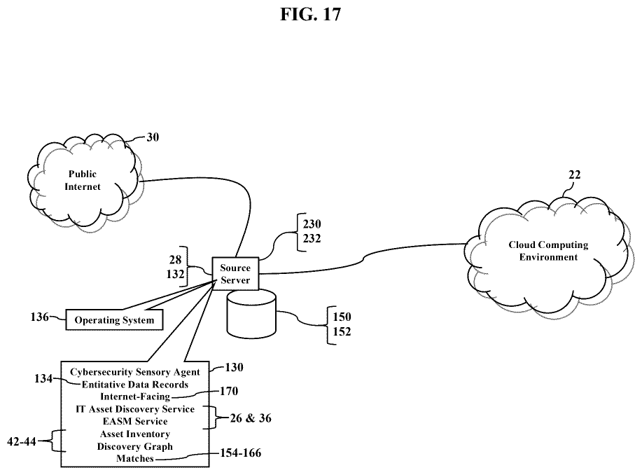

FIG. 17 illustrates some examples of local assessment. When the endpoint cybersecurity sensory agent 130 (installed to the source server 132) detects the entitative data records 134, the cybersecurity sensory agent 130 may locally assess whether the source server 132 has the Internet-facing 170 classification. The endpoint cybersecurity sensory agent 130, in other words, may locally conduct and provide the IT asset discovery service 26 and/or the EASM service 36 with little, or no, reliance on the cloud computing environment 22. The cybersecurity sensory agent 130, for example, is stored in a memory device 230 and executed by a hardware processor (CPU or GPU) 232. The cybersecurity sensory agent 130 cooperates with the operating system 136 and acquires the entitative data records 134. The cybersecurity sensory agent 130 may further include software programming, code, or instructions that locally compare the entitative data records 134 to the IP address scan 150 of the public Internet 30. The source server 132, for example, may locally store the public IP address database 152 in the memory device 232. So, when the cybersecurity sensory agent 130 determines the entitative data records 134, the cybersecurity sensory agent 130 may compare addresses/ports/subnets or other entitative data records 134 to the entries in the public IP address database 152. When the cybersecurity sensory agent 130 determines one or more of the matches 154-166, then the cybersecurity sensory agent 130 may identify its host (e.g., the source server 132) as the Internet-facing 170. The cybersecurity sensory agent 130, in other words, may identify the source server 132 as one of the Internet-facing IT assets 32. The cybersecurity sensory agent 130 may thus locally self-determine whether its host faces, or is exposed to, the public Internet 30 and vulnerable to the cybersecurity attack.

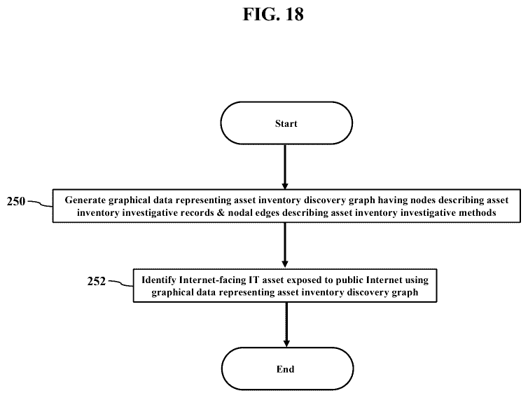

FIG. 18 illustrates examples of a method or operations that identifies the Internet-facing IT asset 32 exposed to the public Internet 30. The computer system 20 providing the service(s) 26/36, for example, generates the graphical data 42 representing the asset inventory discovery graph 44 having the nodes 60 describing the asset inventory investigative records 56 and the nodal edges 62 describing the asset inventory investigative methods 58 (Block 250). The computer system 20 identifies the Internet-facing IT asset 32 exposed to the public Internet 30 using the graphical data 42 representing the asset inventory discovery graph 44 (Block 252).

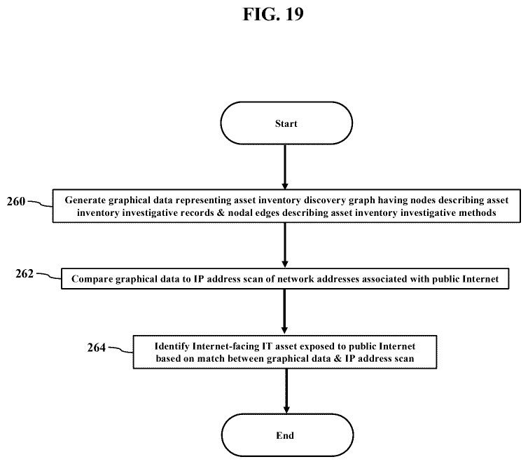

FIG. 19 illustrates more examples of a method or operations that identify the Internet-facing IT asset 32 exposed to the public Internet 30. The graphical data 42 associated with the service(s) 26/36 is generated, and the graphical data 42 represents the asset inventory discovery graph 44 having the nodes 60 describing the asset inventory investigative records 56 and the nodal edges 62 describing the asset inventory investigative methods 58 (Block 260). The graphical data 42 is compared to the IP address scan 150 of network addresses associated with the public Internet 30 (Block 262). The Internet-facing IT asset 32 is identified based on the match 154-166 between the graphical data 42 representing the asset inventory discovery graph 44 and the IP address scan 150 (Block 264).

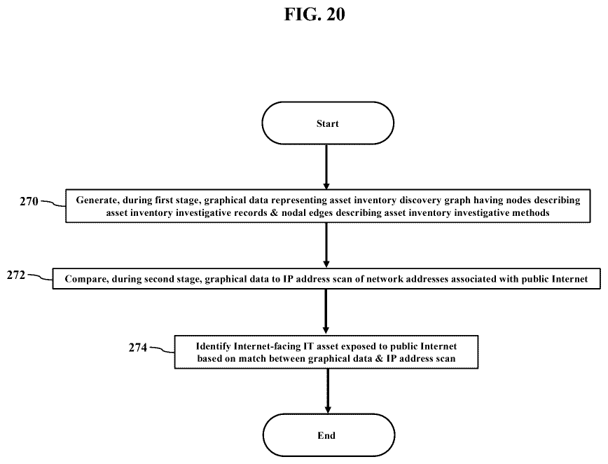

FIG. 20 illustrates still more examples of a method or operations that identify the Internet-facing IT asset 32 exposed to the public Internet 30. The graphical data 42 is generated during the first stage 180 associated with the service(s) 26/36, and the graphical data 42 represents the asset inventory discovery graph 44 having the nodes 60 describing the asset inventory investigative records 56 and the nodal edges 62 describing the asset inventory investigative methods 58 (Block 270). The graphical data 42 is compared during the second stage 182 to the IP address scan 150 of network addresses associated with the public Internet 30 (Block 272). The Internet-facing IT asset 32 is identified during the second stage 182 based on the match 154-166 between the graphical data 42 representing the asset inventory discovery graph 44 and the IP address scan 150 (Block 274).

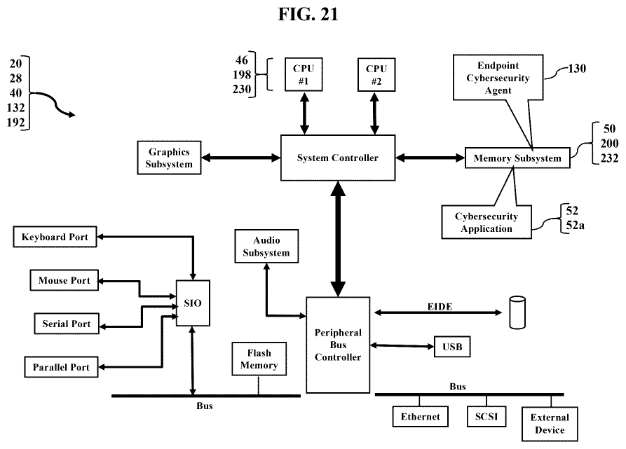

FIG. 21 illustrates a more detailed example of the operating environment. FIG. 21 is a more detailed block diagram illustrating the computer system 20, the data source 28 (such as the data source server 132), the rack server 40, and/or the analyst's computer 192. The cybersecurity application 52, the client-side version 52a of the cybersecurity application, and/or the endpoint cybersecurity sensory agent 130, is stored in the memory subsystem or device 50/200/232. One or more of the hardware processors 46/198/230 communicate with the memory subsystem or device 50/200/232 and execute the cybersecurity application 52, the client-side version 52a of the cybersecurity application, and/or the endpoint cybersecurity sensory agent 130. Examples of the memory subsystem or device 50/200/232 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology. Because the computer system 20, the data source 28 (such as the data source server 132), the rack server 40, and/or the analyst's computer 192 is known to those of ordinary skill in the art, no detailed explanation is needed.

The computer systems 20/28/40/132/192 may have any embodiment. This disclosure mostly discusses the computer systems 20/28/40/132/192 as servers and laptop computers. The IT asset discovery service 26 and/or the EASM service 36, however, may be easily adapted to any stationary or mobile computing, such as a desktop computer, a laptop computer, a tablet computer, a smartwatch, and a network switch/router. The IT asset discovery service 26 and/or the EASM service 36 may also be easily adapted to other embodiments of smart devices, such as a television, an audio device, a remote control, and a recorder. The IT asset discovery service 26 and/or the EASM service 36 may also be easily adapted to still more smart appliances, such as washers, dryers, and refrigerators. Indeed, as cars, trucks, and other vehicles grow in electronic usage and in processing power, the services 26/36 may be easily incorporated into any vehicular controller.

The above examples of the services 26/36 may be applied regardless of the networking environment. The services 26/36 may be easily adapted to stationary or mobile devices having wide-area networking (e.g., 4G/LTE/5G/6G/7G cellular), wireless local area networking (WI-FI®), near field, and/or BLUETOOTH® capability. The services 26/36 may be applied to stationary or mobile devices utilizing any portion of the electromagnetic spectrum and a signaling standard (such as the IEEE 802 family of standards, GSM/CDMA/TDMA or other cellular standard, and/or the ISM band). The services 26/36, however, may be applied to any processor-controlled device operating in the radio-frequency domain and/or the Internet Protocol (IP) domain. The services 26/36 may be applied to any processor-controlled device utilizing a distributed computing network, such as the Internet (sometimes alternatively known as the “World Wide Web”), an intranet, a local-area network (LAN), and/or a wide-area network (WAN). The services 26/36 may be applied to any processor-controlled device utilizing power line technologies, in which signals are communicated via electrical wiring. Indeed, the many examples may be applied regardless of physical componentry, physical configuration, or communications standard(s).

The services 26/36 may utilize a processing component, configuration, or system. For example, the services 26/36 may be easily adapted to a desktop, mobile, or server central processing unit or chipset offered by INTEL®, ADVANCED MICRO DEVICES®, ARM®, APPLE®, TAIWAN SEMICONDUCTOR MANUFACTURING®, QUALCOMM®, or other manufacturer. The services 26/36 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

The services 26/36 may use packetized communications. When the computer systems 20/28/40/132/192 communicate communications networks, information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The services 26/36 may utilize a signaling standard. The computer systems 20/28/40/132/192 and/or the cloud computing environment 22 may mostly use wired networks to interconnect network members. However, the computer systems 20/28/40/132/192 and the cloud computing environment 22 may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or a variant of the GSM/CDMA/TDMA signaling standard. The services 26/36 may also utilize other standards, such as the I.E.E.E. 802 family of standards, the Industrial, Scientific, and Medical band of the electromagnetic spectrum, BLUETOOTH®, low-power or near-field, and other standard or value.

The services 26/36 may be physically embodied on or in a computer-readable storage medium. This computer-readable medium, for example, may include CD-ROM, DVD, tape, cassette, floppy disk, optical disk, USB flash memory drive, memory card, memory drive, and large-capacity disks. This computer-readable medium, or media, could be distributed to end-subscribers, licensees, and assignees. A computer program product comprises processor-executable instructions for identifying Internet-exposed devices, as the above paragraphs explain.

The diagrams, schematics, illustrations, and the like represent conceptual views or processes illustrating examples of cybersecurity command line assessment. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method that identifies an Internet-facing information technology (IT) asset exposed to a public Internet, comprising:
generating, by a computer system providing an external attack surface management service, a graphical data representing an asset inventory discovery graph having nodes describing asset inventory investigative records and nodal edges describing asset inventory investigative methods; and
identifying the Internet-facing IT asset exposed to the public Internet using the graphical data representing the asset inventory discovery graph.

2. The method of claim 1, wherein the generating of the graphical data representing the asset inventory discovery graph further comprises describing a data source as a nodal edge of the nodal edges describing the asset inventory investigative methods.

3. The method of claim 1, wherein the generating of the graphical data representing the asset inventory discovery graph further comprises describing a cybersecurity sensory agent as a nodal edge of the nodal edges describing the asset inventory investigative methods.

4. The method of claim 1, wherein in response to the identifying of the Internet-facing IT asset exposed to the public Internet, further comprising performing a remediation action that reduces exposure to the public Internet.

5. A computer system that identifies an Internet-facing information technology (IT) asset exposed to a public Internet, comprising:
at least one central processing unit; and
at least one memory device storing instructions that, when executed by the at least one central processing unit, perform operations, the operations comprising:
generating a graphical data associated with an external attack surface management service, the graphical data representing an asset inventory discovery graph having nodes describing asset inventory investigative records and edges describing asset inventory investigative methods;
comparing the graphical data representing the asset inventory discovery graph to a scan of network addresses associated with the public Internet; and
identifying the Internet-facing IT asset exposed to the public Internet based on a match between the graphical data representing the asset inventory discovery graph and the scan of the network addresses associated with the public Internet.

6. The computer system of claim 5, wherein the operations further comprise determining a network address as the match between the graphical data representing the asset inventory discovery graph and the scan of the network addresses associated with the public Internet.

7. The computer system of claim 5, wherein the operations further comprise determining a uniform resource locator as the match between the graphical data representing the asset inventory discovery graph and the scan of the network addresses associated with the public Internet.

8. The computer system of claim 5, wherein the operations further comprise determining a domain name service record as the match between the graphical data representing the asset inventory discovery graph and the scan of the network addresses associated with the public Internet.

9. The computer system of claim 5, wherein the operations further comprise determining a subnet as the match between the graphical data representing the asset inventory discovery graph and the scan of the network addresses associated with the public Internet.

10. The computer system of claim 5, wherein the operations further comprise determining a webpage analytic as the match between the graphical data representing the asset inventory discovery graph and the scan of the network addresses associated with the public Internet.

11. The computer system of claim 5, wherein the operations further comprise determining hypertext markup language as the match between the graphical data representing the asset inventory discovery graph and the scan of the network addresses associated with the public Internet.

12. The computer system of claim 5, wherein the operations further comprise determining a text as the match between the graphical data representing the asset inventory discovery graph and the scan of the network addresses associated with the public Internet.

13. The computer system of claim 5, wherein the operations further comprise determining a copyright text as the match between the graphical data representing the asset inventory discovery graph and the scan of the network addresses associated with the public Internet.

14. The computer system of claim 5, wherein the operations further comprise determining a favicon as the match between the graphical data representing the asset inventory discovery graph and the scan of the network addresses associated with the public Internet.

15. The computer system of claim 5, wherein the operations further comprise describing a data source as an edge of the edges describing the asset inventory investigative methods.

16. The computer system of claim 5, wherein the operations further comprise describing a cybersecurity sensory agent as an edge of the edges describing the asset inventory investigative methods.

17. A memory device storing instructions that, when executed by a central processing unit, perform operations, comprising:
generating, during a first stage associated with an external attack surface management service, a graphical data representing an asset inventory discovery graph having nodes describing asset inventory investigative records and edges describing asset inventory investigative methods;
comparing, during a second stage associated with the external attack surface management service, the graphical data representing the asset inventory discovery graph to a scan of network addresses associated with the public Internet; and
identifying, during the second stage associated with the external attack surface management service, an Internet-facing information technology asset exposed to the public Internet based on a match between the graphical data representing the asset inventory discovery graph and the scan of the network addresses associated with the public Internet.

18. The memory device of claim 17, wherein the operations further comprise determining a network address as the match between the graphical data representing the asset inventory discovery graph and the scan of the network addresses associated with the public Internet.

19. The memory device of claim 17, wherein the operations further comprise determining a uniform resource locator as the match between the graphical data representing the asset inventory discovery graph and the scan of the network addresses associated with the public Internet.

20. The memory device of claim 17, wherein the operations further comprise describing a cybersecurity sensory agent as an edge of the edges describing the asset inventory investigative methods.
